(19) United States
(12) Patent Application Publication
(10) Pub. No.: US 2020/0394932 A1
(43) Pub. Date: Dec. 17, 2020

(54) SYSTEMS AND METHODS FOR GENERATING INTERACTIVE ONLINE MATERIAL FOR THERAPY AND LEARNING

(71) Applicant: AMPLIOSPEECH LTD., Haifa (IL)

(72) Inventors: Roni MOSES, Haifa (IL); Yair SHAPIRA, Haifa (IL)

(21) Appl. No.: 16/897,202

(22) Filed: Jun. 9, 2020

Related U.S. Application Data
(60) Provisional application No. 62/860,891, filed on Jun. 13, 2019.

(51) Int. Cl. G09B 7/04; A63F 13/352; A63F 13/79; A63F 13/80

(52) U.S. Cl. CPC G09B 7/04; A63F 13/80; A63F 13/79; A63F 13/352

(57) ABSTRACT

A method for generation of online interactive material usable by one or more clients, the method includes: utilizing a processor: obtaining a game candidate assigned with one or more game attributes, the game candidate includes game material including one or more objects placed on one or more slides of a slide-system, wherein at least some of the one or more objects are associated with at least one attribute and/or with at least one resource; curating the game-candidate if a predetermined set of rules is fulfilled; and converting the game-candidate to a compiled online game, while maintaining the objects, attributes and/or resources thereof.

### CROSS REFERENCE TO RELATED APPLICATIONS

This application is a U.S. non-provisional application, which claims the benefit of priority of U.S. Provisional Application No. 62/860,891 filed on Jun. 13, 2019. The contents of the above applications are all incorporated by reference as if fully set forth herein in their entirety.

### TECHNICAL FIELD OF THE INVENTION

The present disclosure relates generally to systems and methods for generating interactive online material for therapy and learning.

### BACKGROUND OF THE INVENTION

Therapy and learning (together “therapy”) make significant use of practice materials, content, activities and games (together “games”). These games are used to engage the client into therapy by using, for example, fun activities and positive reinforcement and are relevant for the therapy.

Naturally, every client and every therapist or teacher (together “therapist”) are engaged into different games. Games also needs to be changed/replaced often to avoid low or lack of adherence due to boredom and habituation. Picking relevant games also requires breadth of game library.

The digital world enables development, distribution and collaboration of ever-growing libraries of games. Such online games are used with in-person therapy, self-practice on a digital device (computer, laptop, tablet, mobile), or online therapy.

Current methods for generation of online therapy games include graphic software for design of static content, such as tables and lists and cloud-based graphic software for design and sharing of static content.

Software and Software as a Service (SaaS) for design and distribution of dynamic games for therapy, typically single-player games, are designed on proprietary platforms (e.g. http://www.tabloro.com/, https://www.tinytap.it/activities/).

There is still a need in the art for systems and methods for generating more advanced interactive online games for therapy and learning.

### SUMMARY OF THE INVENTION

Aspects of the disclosure, according to some embodiments thereof, relate to advantageous systems and methods for:
a) Simple design and generation of games that enables expansion of large game libraries;
b) Generation of online games that are interactive, for multiple users, such as a therapist and the client/user/student;
c) Producing collaboratively designed games, which can be curated and improved to result in better games;
d) Producing interactive games that yield very specific tests of the client's skills.

According to an aspect of some embodiments, there is provided a method for simple design of online interactive games. The method includes one or more of:
Placing one or more objects on a slide of a slide-system (e.g. PowerPoint);
Optionally associating each of said one or more objects with one or more attributes;
Optionally associating one or more of said objects with one or more resources;
Assigning one or more game attributes; and
Maintaining the obtained game design in an online repository.
Optionally, the games in the repository are categorized and searchable by category. Such categories may include, but are not limited to, age, gender, disorder, grade, level, fields of interest, etc.

According to an aspect of some embodiments, there is provided a method for generation of online interactive games, usable by single or multiple players, using the said simple design. The method includes one or more of:
Obtaining (an online) game candidate assigned with one or more game attributes. The game candidate may include one or more objects placed on a slide of a slide-system, wherein said objects may be associated with one or more attributes and/or with one or more resources;
Converting the game-slide, which includes objects, attributes and resources into an online code, such as but not limited to, Java Script, HTML code, CSS (Cascading Style Sheets), Python, Java and the like;
Enabling the code to run on one or multiple devices (for example, PC, tablets, mobile devices), while synchronizing between the various devices (for example, via network);
Maintaining the obtained game in an online repository (for example, a server).

Advantageously, the methods and systems provided herein can utilize existing Google APIs (application programming interfaces).

According to an aspect of some embodiments, there is provided a method for collaborative generation of online games. The method includes one or more of:
Using a shared slide-system (e.g. Google Slides) to collaboratively design games;
Curating the game-candidate if a predetermined set of rules is fulfilled;
Improving at least one game feature; and
Converting the game-candidate to an online game.

According to an aspect of some embodiments, there is provided a method for testing client's response. The method includes one or more of:
Associating a game-object with a test attribute;
Test attribute includes (a) desired response and/or (b) metrics to use for grading;
Desired response may be retrieved from the associated resource;
When converting the game-candidate to online game, the resulting code includes applying at least one metric to measure the distance between the actual client's response and the desired response;
Storing said metrics in a repository.

According to an aspect of some embodiments, there is provided a method for generation of online interactive material usable by one or more clients, the method includes: utilizing a processor: obtaining a game candidate assigned with one or more game attributes, the game candidate includes game material including one or more objects placed on one or more slides of a slide-system, wherein at least some of the one or more objects are associated with at least one attribute and/or with at least one resource; curating the game-candidate if a predetermined set of rules is fulfilled; and converting the game-candidate to a compiled online game, while maintaining the objects, attributes and/or resources thereof. The method may further include the step of improving at least one game feature.

According to some embodiments, converting the game-candidate to a compiled online game may include applying at least one metric to measure a distance between an actual client's response to the game and/or to the one or more objects and a desired response. The desired response may relate to the object's/objects' location, order, speech input, text input or any combination thereof.

The method may further include the step of producing an online repository/catalog of the games. The games may be categorized and searchable by their category.

According to an aspect of some embodiments, there is provided a system for generation of online interactive material usable by one or more clients, the system includes a processor configured to: obtain a game candidate assigned with one or more game attributes, the game candidate includes game material that includes one or more objects placed on one or more slides of a slide-system, wherein at least some of the one or more objects are associated with at least one attribute and/or with at least one resource; curate the game-candidate if a predetermined set of rules is fulfilled; and convert the game-candidate to a compiled online game, while maintaining the objects, attributes and/or resources thereof. The processor may further be configured to improve at least one game feature.

According to some embodiments, converting the game-candidate to a compiled online game may include applying at least one metric to measure a distance between an actual client's response to the game/ to the one or more objects and a desired response.

The processor may further be configured to produce an online catalog of the games. The games may be categorized and searchable by their category.

According to some embodiments, the desired response may relate to the object/objects' location, order, speech input, text input or any combination thereof. The one or more objects may include an image, graphic object, symbol, picture, text or any combination thereof.

According to some embodiments, the one or more game attributes may include game name, instructions, age relevance, tag or any combination thereof. The at least one attribute associated with the one or more objects may include an order of an object, movability of an object, flip-ability of an object, desired result of using this object, randomizing selection of an object from a group of objects, resources of an object or any combination thereof.

According to some embodiments, the slide-system may be a shared slide system facilitating designing games collaboratively.

According to some embodiments, there are provided herein methods and systems for generating a game template. Such game template may include “placeholders” which may, at a later stage, be replaced by content such as automatically generated/fetched content. The content may be retrieved from associated resource. The content may be selected according to the specific need and may include, for example, words with a predetermined number of letters (e.g., 5, 6, etc.), images of sport teams, words that include the letter S, etc.

According to some embodiments, a method as disclosed herein is a computerized method. Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not to scale.

In the Figures:

FIG. 1 schematically depicts a flowchart of the method for generation of online interactive games usable by multiple users, according to some exemplary embodiments.

### DETAILED DESCRIPTION OF THE INVENTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, the words “include” and “have”, and forms thereof, are not limited to members in a list with which the words may be associated.

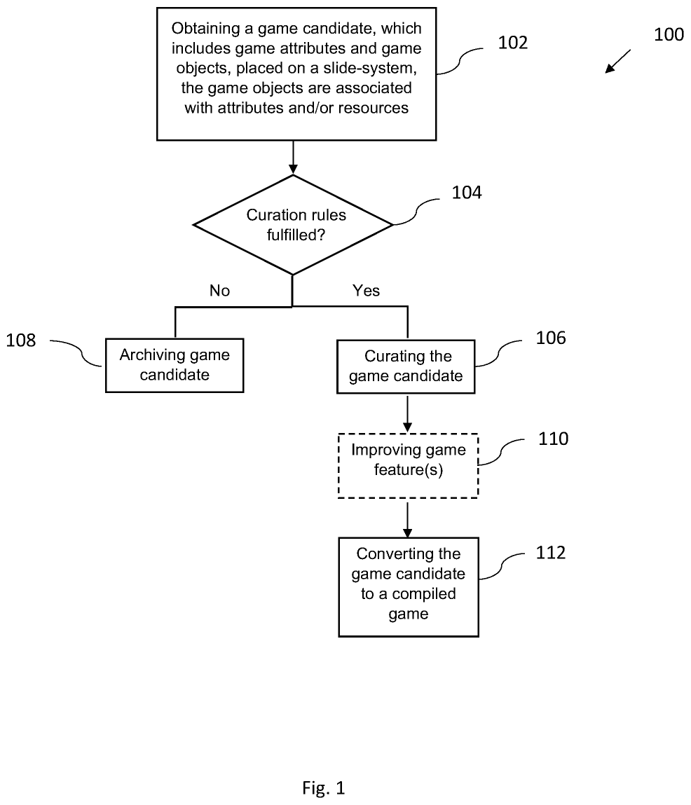

Reference is now made to FIG. 1 schematically depicts a flowchart 100 of the method for generation of online interactive games usable by one or more users/clients, according to some exemplary embodiments. Step 102 of flowchart 100 includes obtaining a game candidate, which includes game attributes and objects (e.g., game objects), placed on a slide-system (e.g., shared slide-system), the objects are associated with attributes and/or resources. The game candidate is then subjected to a curation set of rules (step 104). If the rules are fulfilled, the game candidate is curated (step 106). If the rules are not fulfilled, the game candidate may be archived (step 108). After the game candidate is curated, one or more game features may optionally be improved (step 110). The game candidate is then converted to a compiled game (step 120) and may then be posted online, for example as part of a game catalog.

According to some exemplary embodiments, the method of designing the on-line game may include one or more of:
1.1. Placing objects on a slide, using standard slide-systems such as MS-PPT or Google-Slides. Objects may include image, graphic object, text, audio or video files, and the like, or any combination thereof. Examples of objects may include, background image, cards, dice, pawn or any combination thereof. Each possibility is a separate embodiment.
1.2. Associating an object with attributes, using standard slide-system metadata. Attributes are defined by an innovative meta-data language (as detailed below). Attribute examples may include movability, flip-ability, resources, desired response, metrics to measure response vs. desired response, or any combination thereof. Each possibility is a separate embodiment.
1.3. Associating an object with resources. For example, a card-deck can be associated with a resource directory of images of animals.
1.4. Game attributes. For example, game name, instructions, age relevance, tags, or any combination thereof. Each possibility is a separate embodiment.

2. Game design collaboration, curation and improvement
2.1. Advantageously, games, according to some embodiments, can be designed by non-professionals, for example by therapists and/or by clients. Furthermore, multiple designers can submit games or work collaboratively on a single game, using slide systems, such as, Google Slides or MS-PPT-Online.
2.2. Storing designed-game candidates in an online repository, reviewing the games by an expert and curating the selected games. Designed game-candidates are kept/stored in an online repository (for example, a server). These games are reviewed by an expert. Only the selected games (also referred to as best games), (e.g., games that comply with certain rules) are curated and kept.
2.3. Curated game-candidates may undergo improvement(s), including, for example, ensuring all content can be legally used (e.g., not under copyright, not offensive, etc.), improving the graphics, validating tagging and attributes, or any combination thereof. Each possibility is a separate embodiment.

3. Automatic conversion of the game design to an online game.
3.1. Reading every slide in the repository, corresponding to a single game. The system reads every slide in the repository, corresponding to a single game. Reading includes, for example, retrieving game-attributes, game-objects, object-attributes and/or object-resources. Each possibility is a separate embodiment.
3.2. Converting the retrieved data from the design into an online script, object code or executable program. The system converts the retrieved data from the design into an online script, object code or executable, such as Java Script (together “compiled games”). The resulting compiled games maintain the game design, including all its features.

4. Games catalog
4.1. All or some of the compiled games may be arranged in a games catalog.
4.2. The catalog can be sorted (e.g., newest games first), filtered (e.g., only for ages 3-5) and searched (e.g., animals).

5. Game play, data externalization and tests
5.1. Once a compiled game is selected, the users can play the game on their device (for example, PC, mobile device (such as, smart phone, tablet, etc.).
5.2. Games can be played by single, dual or multi-player.
5.3. The games are built out of distinct objects, as specified in the design. The system externalizes every step taken with an object, for example flipping a card. Externalization includes, for example, writing all activities into a log. The log may include, for example
   date and time stamp, user carrying out the activity, the nature of the activity, the resource applied (e.g. the picture presented).
5.4. In case an object includes a test attribute, the compiled game analyzes the user's response (e.g. recorded speech) vs. the desired response (e.g. name of the animal) according to the metrics specified in the design. These tests are also externalized.

According to some embodiments, the term “game” relates to a virtual game. In some examples, the game may be played/executed on a computer's (or other device) local resources and/or on remote server, via, for example, the internet or the World Wide Web.

According to some embodiments, the term “client” may refer to any user such as but not limited to, a student.

According to some embodiments, a slide-system relates to an application or executable software for presenting and/or editing slides. For example, a slide-system is PowerPoint® slide show presentation program. PowerPoint (MS-PPT) is a registered trademark of the Microsoft Corporation. For example, a slide-system is “Google Slides”. Examples of Objects' Attributes, according to some embodiments may include such attributes as, but not limited to:
Location—The original location of the object
Order—Which object is on top of which
Movability—Which objects can be dragged, e.g., pawns in monopoly.
Flipability—Objects flipped like cards and their backside.
Deck—Cards in a deck.
Resource—Container objects that randomly select from a resource, e.g., memory cards game, with card images randomly selected from a library.
Desired result of using the object, for example:
   Location—“it should be dragged to”, e.g., zebra should be dragged to the zoo.
   Order—“it should be placed in”, e.g., big should be placed right of small.
   Speech—“it should induce”, e.g., client should say “Snake”.
   Text input—“it should be”, e.g. text should be “Hello”.

According to some embodiments, a server may include a virtual machine or a physical machine that includes one or more processors and one or more memory devices. A processor may include a central processing unit (CPU), a microprocessor, an application specific integrated circuit (ASIC), a programmable logic device (PLD), and the like, or combinations thereof.

In some embodiments, a system may include one or more of: microprocessor of various types (for example, a central processing unit (CPU) and/or a graphics processing unit (GPU) and/or a digital signal processor (DSP)), a memory of various types (for example, a video random access memory (VRAM), a random access memory (RAM), and a read only memory (ROM)), a communication unit, a display, a GUI, or any combinations thereof.

Unless specifically stated otherwise, as apparent from the disclosure, it is appreciated that, according to some embodiments, terms such as “processing”, “computing”, “calculating”, “determining”, “estimating”, “assessing”, “gauging”, “generating” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices.

Embodiments of the present disclosure may include apparatuses for performing the operations herein disclosed. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although steps of methods according to some embodiments may be described in a specific sequence, methods of the disclosure may include some or all of the described steps carried out in a different order. A method of the disclosure may include a few of the steps described or all of the steps described. No particular step in a disclosed method is to be considered an essential step of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

What is claimed is:

1. A method for generation of online interactive material usable by one or more clients, the method comprising:
utilizing a processor
obtaining a game candidate assigned with one or more game attributes, the game candidate comprises game material comprising one or more objects placed on one or more slides of a slide-system, wherein at least some of the one or more objects are associated with at least one attribute and/or with at least one resource;
curating the game-candidate if a predetermined set of rules is fulfilled; and
converting the game-candidate to a compiled online game, while maintaining the objects, attributes and/or resources thereof.

2. The method of claim 1, further comprising the step of improving at least one game feature.

3. The method of claim 1, wherein converting the game-candidate to a compiled online game comprises applying at least one metric to measure a distance between an actual client's response to the game or to the one or more objects and a desired response.

4. The method of claim 3, wherein the desired response relates to the object's/objects' location, order, speech input, text input or any combination thereof

5. The method of claim 1, wherein the one or more objects comprise an image, graphic object, symbol, picture, text or any combination thereof.

6. The method of claim 1, wherein the one or more game attributes comprise game name, instructions, age relevance, tag or any combination thereof.

7. The method of claim 1, wherein the at least one attribute associated with the one or more objects comprises an order of an object, movability of an object, flip-ability of an object, desired result of using this object, randomizing selection of an object from a group of objects, resources of an object or any combination thereof.

8. The method of claim 1, wherein the slide-system is a shared slide system facilitating designing games collaboratively.

9. The method of claim 1, further comprising producing an online catalog of the games.

10. The method of claim 9, wherein the games are categorized and searchable by their category.

11. A system for generation of online interactive material usable by one or more clients, the system comprising a processor configured to:
obtain a game candidate assigned with one or more game attributes, the game candidate comprises game material comprising one or more objects placed on one or more slides of a slide-system, wherein at least some of the one or more objects are associated with at least one attribute and/or with at least one resource;
curate the game-candidate if a predetermined set of rules is fulfilled; and
convert the game-candidate to a compiled online game, while maintaining the objects, attributes and/or resources thereof.

12. The system of claim 11, wherein the processor is further configured to improve at least one game feature.

13. The system of claim 11, wherein converting the game-candidate to a compiled online game comprises applying at least one metric to measure a distance between an actual client's response to the game/ to the one or more objects and a desired response.

14. The system of claim 13, wherein the desired response relates to the object's/objects' location, order, speech input, text input or any combination thereof.

15. The system of claim 11, wherein the one or more objects comprise an image, graphic object, symbol, picture, text or any combination thereof.

16. The system of claim 11, wherein the one or more game attributes comprise game name, instructions, age relevance, tag or any combination thereof.

17. The system of claim 11, wherein the at least one attribute associated with the one or more objects comprises an order of an object, movability of an object, flip-ability of an object, desired result of using this object, randomizing selection of an object from a group of objects, resources of an object or any combination thereof.

18. The system of claim 11, wherein the slide-system is a shared slide system facilitating designing games collaboratively.

19. The system of claim 11, wherein the processor is further configured to produce an online catalog of the games.

20. The system of claim 19, wherein the games are categorized and searchable by their category.
